(19) United States
(12) Patent Application Publication
(10) Pub. No.: US 2008/0097077 A1
(43) Pub. Date: Apr. 24, 2008

(54) Method For Producing Polyoxymethylenes

(75) Inventors: Jens Assmann, Mannheim (DE); Knut Zollner, Mannheim (JP); Mark Blinzler, Mannheim (DE); Melanie Urtel, Edingen-Neckarhausen (DE); Claudius Schwittay, Mannheim (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 11/908,729

(22) PCT Filed: Mar. 15, 2006
(86) PCT No.: PCT/EP06/60751

§ 371 Date: Sep. 14, 2007

(30) Foreign Application Priority Data
Mar. 16, 2005 (DE) 10 2005 012 482.8

(51) Int. Cl. C08G 2/06

(52) U.S. Cl. 528/425

(57) ABSTRACT

A process for the preparation of polyoxymethylenes by cationic polymerization of the monomers a) in the presence of initiators b) and, if appropriate, in the presence of regulators c) and subsequent deactivation and isolation of the polymer, wherein the total amount of proton donors is less than 5000 ppm in the entire polymerization.

The invention relates to an improved process for the preparation of polyoxymethylenes.

Various processes which predominantly comprise proton donors/protic compounds in the reaction mixture are known from the prior art:

In DE-A 361 77 54 or DE-A 292 07 03, for example, alcohols are used as regulators/chain transfer agents. As a rule, the terminating agent is introduced into the mixture in alcoholic solvents:
DE-A 361 77 54 hydrolysis with H₂O/alcohol mixtures
DE-A 250 99 24 NEt₃ is added in MeOH/H₂O (NEt₃=triethylamine)
JP-A 59/197 415 NEt₃ is added in ethanol
WO 97/24 384 NEt₃ is added in water
EP-A 999 224 deactivator may be present in the aqueous phase

According to textbooks, such as Echte, Handbuch der Polymerchemie, VCH, Weinheim, 1993, section 8.5.2, POM copolymers are neutralized by alkali after cationic polymerization.

Furthermore, POM polymers may also be devolatilized using steam: DE-A 370 73 90.

EP-A 678 535 discloses that the water content of the monomer mixture should advantageously be limited. In the further steps of the polymerization, low boilers and H donors are not limited.

In the abovementioned publications, low-boiling inert solvents (boiling point below 140° C.) are used as solvents, for example for the catalysts, since said solvents are easier to remove.

The polymerization of trioxane gives, as a rule, yields of <100%. In the melt polymerization, only 70% conversions are achieved, for example. The unconverted residual monomers are as a rule separated off in gaseous form and recycled. This recycling of the vapor is considerably facilitated if they are very substantially free of low boilers. In this case, complicated purification of the vapors can be avoided. If the vapors are free of proton donors, there is no (gas-phase) polymerization which leads to troublesome deposits in the feed pipes.

A decisive quality criterion for polyoxymethylenes is moreover the residual formaldehyde content (residual FA). It is desirable to reduce the residual FA to substantially <10 ppm. A low residual FA is equivalent to a high thermal stability of the polymer (i.e. with a low mass loss under thermal load).

In this context, it is decisive that the polymer chains have no unstable end groups.

It was therefore the object of the present invention to minimize the unstable chain ends and residual FA, to increase the thermal stability of the polymer and to simplify the recycling of the monomers, as well as to prolong the service lives of the pipes and apparatuses for the recycling.

Accordingly, a process for the preparation of polyoxymethylenes by cationic polymerization of the monomers a) in the presence of initiators b) and, if appropriate, in the presence of regulators c) and subsequent deactivation and isolation of the polymers was found, wherein the total amount of proton donors is less than 5000 ppm in the entire polymerization. Preferred embodiments are described in the subclaims.

Surprisingly, the stability of the POM chains (chain ends) can be considerably increased if the proportion of the proton donors is limited in said quantity range in the polymerization. The working-up can be carried out more effectively and with less wear, in particular on additional limitation of the low boilers—except for the monomers used—in the reaction system.

The term “entire polymerization” comprises all process steps from the monomer batch to the granules.

The process can be carried out in principle in any reactor having a high mixing effect, such as, for example, dishes, plowshare mixers, tubular reactors, List reactors, kneaders, stirred reactors, extruders and belt reactors.

Examples of suitable reactors are: Kenics (Chemineer Inc.); interfacial surface generator ISG and low pressure drop mixer (Ross Engineering Inc); SMV, SMX, SMXL, SMR (Sulzer Koch-Glitsch); Inliner series 45 (Lightnin Inc.); CSE mixer (Fluitec Georg AG).

The resulting POM polymers are known per se to the person skilled in the art and are described in the literature.

Very generally, these polymers have at least 50 mol % of repeating units —CH₂O— in the polymer main chain.

The homopolymers are generally prepared by the polymerization of monomers a) such as formaldehyde or trioxane, preferably in the presence of suitable catalysts.

In the invention, polyoxymethylene copolymers are preferred, in particular those which, in addition to repeating units —CH₂O—, also comprise up to 50, preferably from 0.01 to 20, in particular from 0.1 to 10, mol % and very particularly preferably from 0.5 to 3 mol % of repeating units 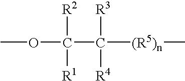
where R¹ to R⁴, independently of one another, are a hydrogen atom, a C₁- to C₄-alkyl group or a halogen-substituted alkyl group having 1 to 4 carbon atoms and R⁵ is a —CH₂—, —CH₂O—, a C₁- to C₄-alkyl or C₁- to C₄-haloalkyl-substituted methylene group or a corresponding oxymethylene group and n has a value in the range from 0 to 3. Advantageously, these groups can be introduced into the copolymers by ring opening of cyclic ethers. Preferred cyclic ethers are those of the formula 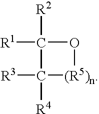
where R¹ to R⁵ and n have the abovementioned meaning. Merely by way of example, ethylene oxide, 1,2-propylene oxide, 1,2-butylene oxide, 1,3-butylene oxide, 1,3-dioxane, 1,3-dioxolane and 1,3-dioxepane may be mentioned as cyclic ethers, and linear oligo- or polyformals, such as polydioxolane or polydioxepane, as comonomers.

Also suitable are oxymethylene terpolymers, which are prepared, for example, by reacting trioxane and one of the cyclic ethers described above with a third monomer, preferably bifunctional compounds of the formula 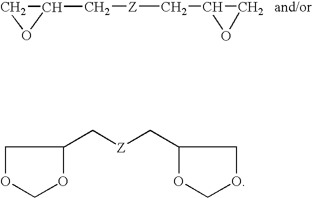
where Z is a chemical bond, —O—, —ORO— (R is C₁- to C₈-alkylene or C₃- to C₈-cycloalkylene).

Preferred monomers of this type are ethylene diglycide, diglycidyl ether and diethers obtained from glycidyls and formaldehyde, dioxane or trioxane in the molar ratio 2:1 and diethers obtained from 2 mol of glycidyl compound and 1 mol of an aliphatic diol having 2 to 8 carbon atoms, such as, for example, diglycidyl ethers of ethylene glycol, 1,4-butanediol, 1,3-butanediol, cyclobutane-1,3-diol, 1,2-propanediol and cyclohexane-1,4-diol, to mention but a few examples.

End group-stabilized polyoxymethylene polymers which have C—C or —O—CH₃ bonds at the chain ends are particularly preferred.

The preferred polyoxymethylene copolymers have melting points of at least 150° C. and molecular weights (weight average) M_{W} in the range from 5000 to 300 000, preferably from 7000 to 250 000.

Particularly preferred POM copolymers are those having a polydispersity (M_{W}/Mₙ) of from 2 to 15, preferably from 3 to 12, particularly preferably from 3.5 to 9. The measurements are effected as a rule by means of GPC/SEC (size exclusion chromatography), and the Mₙ value (number average molecular weight) is generally determined by means of GPC/SEC (size exclusion chromatography).

The POM polymers obtainable by the process preferably have a monomodal molecular weight distribution, the low molecular weight fraction being small.

The polyoxymethylene homo- or copolymers have in particular quotients of the d₅₀/d₁₀ values (based on M_{W}) of from 2.25 to 5.5, preferably from 2.75 to 5 and in particular from 3.2 to 4.5. The quotient of the d₉₀/d₅₀ values (based on M_{W}) is preferably from 1.25 to 3.25, preferably from 1.75 to 2.75 and in particular from 2 to 2.5.

The POM polymers have very small low molecular weight fractions and preferably an asymmetrical, monomodal distribution curve, the difference between the above-mentioned quotients d₅₀/d₁₀ and d₉₀/d₅₀ being at least 0.25, preferably from 1 to 3 and in particular from 1.0 to 2.3.

The molar mass determination by GPC (gel permeation chromatography):

Eluent: hexafluoroisopropanol+0.05% of trifluoroacetic acid potassium salt

Column temperature: 40° C.

Flow rate: 0.5 ml/min

Detector: differential refractometer Agilent G1362A.

The calibration was effected using PMMA standards having a narrow distribution from PSS, with molecular weights of M=505 to M=2 740 000. Elution ranges outside this interval were estimated by extrapolation.

A d₅₀ value is as a rule understood by the person skilled in the art as meaning the value at which 50% of the polymer have a lower M_{W} and correspondingly 50% a higher M_{W}.

The crude polyoxymethylenes obtainable by the process according to the invention preferably have a residual formaldehyde content, according to VDA 275, of not more than 1%, preferably not more than 0.1%, preferably not more than 0.01% in the granules.

The process according to the invention is preferably used for the homopolymerization and the copolymerization of trioxane. However, in principle any of the monomers described above, for example also tetroxane, can be used as monomer a).

The monomers, for example trioxane, are preferably metered in in the molten state, in general at temperatures of from 60 to 180° C.

The temperature of the reaction mixture during the metering is preferably from 62 to 170° C., in particular from 120 to 160° C.

The molecular weights of the polymer can, if appropriate, be adjusted to the desired values by means of the regulators c) customary in the (trioxane) polymerization. Suitable regulators are acetals or formals of monohydric alcohols, the alcohols themselves and the small amounts of water which act as chain transfer agents, the presence of which as proton donors can generally never be completely avoided. The regulators are used in amounts of from 10 to 10 000 ppm, preferably from 50 to 5000 ppm. According to the invention, the amount of such regulators should be limited as mentioned below.

The cationic initiators customary in the (trioxane) polymerization are used as initiators b) (also referred to as catalysts). Protic acids, such as fluorinated or chlorinated alkanesulfonic and arylsulfonic acids, e.g. perchloric acid or trifluoromethanesulfonic acid, or Lewis acids, such as, for example, tin tetrachloride, arsenic pentafluoride, phosphorus pentafluoride and boron trifluoride, and the complex compounds and salt-like compounds thereof, e.g. boron trifluoride etherates and triphenylmethylene hexafluorophosphate, are suitable. The catalysts (initiators) are used in amounts of from 0.001 to 1000 ppm, preferably from 0.01 to 500 ppm and in particular from 0.05 to 10 ppm. In general, it is advisable to add the catalyst in dilute form, preferably in concentrations of from 0.005 to 5% by weight. Inert compounds, such as aliphatic or cycloaliphatic hydrocarbons, e.g. cyclohexane, halogenated aliphatic hydrocarbons, glycol ethers, cyclic carbonates, such as propylene carbonate, or lactones, e.g. γ-butyrolactone, or ketones, such as 6-undecanone, and triglyme (triethylene glycol dimethyl ether) and 1,4-dioxane, may be used as solvents for this purpose. According to the invention, the amounts of such low boilers should be limited as mentioned below.

Monomers and comonomers a), initiators b) and, if appropriate, regulators c) can be premixed in any desired manner or added to the polymerization reactor separately from one another. Furthermore, the components a), b) and/or c) may comprise sterically hindered phenols, as described in EP-A 129 369 or EP-A 128 739, for stabilization.

In order to minimize the proportion of unstable end groups, it has proven advantageous to dissolve the initiator b) in the regulator c) before the addition thereof to the monomer a) and, if appropriate, comonomer a).

The polymerization is preferably carried out in a tubular reactor which has a mixing zone, a polymerization zone and a deactivation zone.

According to the invention, the polymerization mixture is deactivated directly after polymerization, preferably without a phase change taking place.

The deactivation of the catalyst residue is effected as a rule by adding at least one deactivator d).

Suitable deactivators are, for example, ammonia, aliphatic and aromatic amines and basic salts, such as sodium carbonate and borax. These are usually added to the polymers in amounts of, preferably, up to 1% by weight.

The organic compounds of the alkali metals or alkaline earth metals, preferably of sodium, include the corresponding salts of (cyclo)aliphatic, araliphatic or aromatic carboxylic acids having, preferably, up to 30 carbon atoms and preferably 1 to 4 carboxyl groups. Examples of these are: alkali metal salts of formic acid, acetic acid, propionic acid, butyric acid, isobutyric acid, caprylic acid, stearic acid, cyclohexanecarboxylic acid, succinic acid, adipic acid, suberic acid, 1,10-decane-dicarboxylic acid, 1,4-cyclohexanedicarboxylic acid, terephthalic acid, 1,2,3-propanetricarboxylic acid, 1,3,5-cyclohexanetricarboxylic acid, trimellitic acid, 1,2,3,4-cyclopentanetetracarboxylic acid, pyromellitic acid, benzoic acid, substituted benzoic acids, dimeric acids and trimeric acids and neutral and partially neutral montan wax salts or montan wax ester salts (montanates). Salts having acid radicals of other types, such as, for example, alkali metal paraffinsulfonates, alkali metal olefinsulfonates and alkali metal arylsulfonates or phenolates and alcoholates, such as, for example, methanolates, ethanolates or glycolates, can also be used according to the invention. Sodium salts of mono- and polycarboxylic acids, in particular the aliphatic mono- and polycarboxylic acids, preferably those having 2 to 18 carbon atoms, in particular having 2 to 6 carbon atoms, and up to four, preferably up to two, carboxyl groups, and sodium alcoholates having, preferably, 2 to 15, in particular 2 to 8, carbon atoms are preferably used. Examples of particularly preferred members are sodium acetate, sodium propionate, sodium butyrate, sodium oxalate, sodium malonate, sodium succinate, sodium methanolate, sodium ethanolate and sodium glyconate. Sodium methanolate is very particularly preferred and is particularly advantageously used in an amount of 1-5 times the equimolar amount of component b) used. Mixtures of different alkali metal or alkaline earth metal compounds may also be used, it also being possible to use hydroxides.

Furthermore, alkaline earth metal alkyls which have 2 to 30 carbon atoms in the alkyl radical are preferred as deactivators d). Li, Mg and Na may be mentioned as particularly preferred metals, n-butyllithium being particularly preferred.

Preferred deactivators d) are those of the formula I 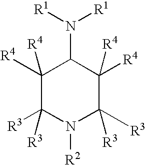
where R¹, R³, R⁴ and R⁵, independently of one another, are hydrogen or a C₁-C₁₀-alkyl group and

R² is hydrogen or a C₁-C₁₀-alkyl group or O—R⁵.

Preferred radicals R¹ to R⁵ are, independently of one another, hydrogen or a C₁-C₄-alkyl group, such as methyl, ethyl, n-propyl, isopropyl, n-butyl, isobutyl, sec-butyl or tert-butyl.

Particularly preferred deactivators d) are substituted N-containing heterocycles, in particular derivatives of piperidine, triacetonediamine (4-amino-2,2,6,6-tetramethylpiperidine) being particularly preferred.

The deactivator is metered in in amounts of from 0.001 to 25 ppm, preferably from 0.01 to 5 ppm, in particular from 0.05 to 2 ppm, based on the throughput of trioxane. The deactivator is preferably present in dilute form in one of the above-mentioned carriers/solvents. The concentration of the deactivator in the carrier/solvent is from 0.001 to 10%, preferably from 0.01 to 5%, in particular from 0.05 to 2%, very particularly preferably from 0.1 to 1%.

The deactivator d) is preferably added in an aprotic, nonaromatic solvent, for example the abovementioned monomers and comonomers, such as dioxolane, trioxane, butanediol formal, ethylene oxide or oligomeric to polymeric polyacetals.

In a particularly preferred embodiment of the process according to the invention, the deactivator d) is added to the polymerization mixture in a carrier substance having ether structural units.

Preferably, carrier substances which have the same structural units as those present in the POM polymer to be prepared in each case are suitable. These are to be understood in particular as meaning the abovementioned monomers a) and oligomeric to polymeric polyoxymethylene or polyacetals.

The preferably liquid addition is effected at temperatures of from 140 to 220° C.

If oligomeric or polymeric POM polymers are used as carrier substances, addition in liquid form at temperatures of from 160 to 220° C. is likewise preferred. Such polymers can, if appropriate, comprise conventional additives. Apparatuses such as the side extruder, plug screw, melt pump, etc. are preferably used for metering such melts of the carrier substances which comprise the deactivators d).

As a rule, the polymer formed is then transferred to a devolatilizing apparatus.

The corresponding polyoxymethylene polymer can then be further processed with conventional additives, such as stabilizers, rubbers, fillers, etc., in a conventional manner.

According to the invention, the total amount of proton donors should be less than 5000 ppm, preferably from 0.1 to 2000 ppm, in particular from 1 to 1000 ppm and very particularly preferably from 10 to 750 ppm in the entire polymerization.

Proton donors having at least one OH group are preferably used. In particular, they have a molecular weight of <250 g/mol, preferably <200 g/mol.

According to Brönstedt/Lowry, proton donors are understood as meaning compounds which can donate protons (cf. Römpp Chemie Lexikon, 9th edition 1992, pages 3958 and 3959). In the procedure according to the invention, these include in particular aliphatic/aromatic alcohols (solvents for regulators c) and also d)), which may be saturated or unsaturated, and water or water-comprising solutions of reactants as well as the abovementioned (Lewis) acids as initiators b).

In order to comply with these quantity limits, it is advantageous to use in particular a formal, such as methylal or butyral, as chain regulator c). Furthermore, it is advantageous to use the above carrier substances (having ether units), e.g. lactones, such as γ-butyrolactone, ketones, such as 6-undecanone, or cyclic carbonic esters, as solvents for the initiator b) or the terminating agent d).

Cyclic carbonic esters which may be used are preferably those having 5 ring members, in particular compounds of the formula 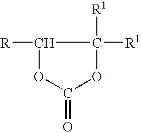
where R is a hydrogen atom, a phenyl radical or a lower alkyl radical, preferably having 1, 2 or 3 carbon atoms, and R¹ in each case is a hydrogen atom or a lower alkyl radical, preferably having 1, 2 or 3 carbon atoms. The following may be mentioned as examples: ethylene glycol carbonate, 1,2-propylene glycol carbonate, 1,2-butylene glycol carbonate, 2,3-butylene glycol carbonate, phenylethylene glycol carbonate, 1-phenyl-1,2-propylene glycol carbonate and 2-methyl-1,2-propylene glycol carbonate (1,3-dioxolan-2-one, 4-methyl-1,3-dioxolan-2-one, 4-ethyl-1,3-dioxolan-2-one, 4,5-dimethyl-1,3-dioxolan-2-one, 4-phenyl-1,3-dioxolan-2-one, 4-methyl-5-phenyl-1,3-dioxolan-2-one, and 4,4-dimethyl-1,3-dioxolan-2-one).

The cyclic carbonic esters used according to the invention have a purity of at least 95%, preferably of at least 99.9%; they should be substantially water-free and alkali-free. The purification is generally effected by distillation under reduced pressure or by absorption or by adsorption. If the purified cyclic carbonic esters are present in the solid state of aggregation under standard temperature and pressure conditions, it must be brought into the liquid state of aggregation for the preparation of the initiator solution by melting; this is effected by heating to a temperature which is from 5 to 10° C. above the melting point of the respective carbonic ester. In general, a temperature of from 35 to 100° C., preferably from 45 to 80° C., is sufficient for this purpose.

According to the invention, the devolatilization should furthermore take place in the absence of oxygen or under an inert gas, in particular under nitrogen.

In addition, it is advantageous for the recycling of the residual monomers to limit the amount of low boilers in the reaction system—with the exception of the monomers used—to be precise from 0.1 to 15 000 ppm, preferably from 0.1 to 2000 ppm and in particular from 0.1 to 750 ppm.

In the context of the invention, low boilers are understood as meaning compounds having a boiling point of <160° C., preferably <140° C. and in particular <120° C.

The molar mass of such low boilers is preferably <400 g/mol, preferably <300 g/mol and in particular <200 g/mol.

Such low-boilers in the system are preferably aprotic solvents, as already mentioned above under b). Protic solvents comprise relatively mobile protons which are generally bonded to oxygen, nitrogen or sulfur. In the case of the aprotic solvents, all hydrogen atoms are bonded to carbon (cf. F. A. Carey, R. J. Lundberg, Organische Chemie Verlag VCH 1995, page 224).

However, it is not advantageous completely to dispense with protic compounds, since protic compounds can initiate and accelerate polymerization (aqueous perchloric acid serves as an initiator of the reaction), but can also effectively terminate the reaction (TAD serves as a terminating agent and comprises small amounts of water).

By combining the following measures according to the invention, the proportion of protic compounds in the reaction mixture is reduced:
1. A formal, preferably methylal or butyral, is used as the chain regulator.
2. A cyclic formal serves as a solvent for the terminating agent.
3. Aprotic compounds having a boiling point >160° C. serve as solvents for the initiator.
4. All starting materials have a water content of not more than 500 ppm.

Low molecular weight protic compounds are thus introduced into the reaction mixture in the process according to the invention merely via the initiator (e.g. aqueous perchloric acid), and the terminating agent (e.g. TAD) and the residual water are introduced into the reaction mixture in the starting materials. The residual water accounts for the greatest proportion of protic compounds introduced according to the invention.

### EXAMPLES

5 kg of a mixture of 96.495% by weight of a liquid trioxane, 3.5% by weight of dioxolane and 0.005% by weight of methylal were heated to 160° C. and pumped into a tubular reactor having static mixers. The residual water content of these monomers was in each case 0.05%. By adding 0.5 ppm of perchloric acid (as a 0.01% strength by weight solution in solvent A), the polymerization was initiated; the pressure in the reactor was 20 bar.

After a residence time of 2 min, triacetonediamine was metered in as the terminating agent (as a 0.05% strength by weight solution in solvent B) in the terminating zone of the reactor, so that TAD was present in a 5-fold excess relative to the perchloric acid, and was mixed in by means of a static mixer.

After a further residence time of 3 min, the product (crude POM) was let down to a pressure of 4 bar via a control valve into a devolatilization vessel, with the result that the volatile components were separated off from the polymer melt. Residues of trioxane and formaldehyde remained in the polymer melt.

The gaseous monomers were transferred from the devolatilization vessel via a pipeline heated to 130° C.—referred to below as the vapor line—into a condenser and condensed. The condensate was investigated by GC-MS measurements.

The melt was devolatilized on an extruder, discharged, cooled in a waterbath and granulated.

The proportion of low molecular weight protic compounds in the reaction mixture was thus:
500 ppm (residual water of the monomers)+
0.25 ppm (from the 70% strength aqueous perchloric acid)+
2.5 ppm (triacetonediamine)=
502.75 ppm
   and—depending on the choice of the solvents—
+5000 ppm solvent B (e.g. water, methanol)

The proportion of low boilers in the reaction mixture is—depending on the choice of the solvent—

5000 ppm solvent A (e.g. 1,4-dioxane, cyclohexane)

| | | | | | Amount of | | | | | |
|---|---|---|---|---|---|---|---|---|---|---|
| | Solvent | Solvent | Amount of | | proton | | Analysis of the | Deposit in the vapor | Service life of | |
| Example | A | B | low boilers | | donators | | condensate | lines | the vapor line | |
| According | propylene | 1,3-dioxolane | <10 | ppm | 503 | ppm | traces of solvent A | no deposit formation | >240 | h |
| to the | carbonate | | | | | | | | | |
| invention | | | | | | | | | | |
| Compar- | cyclohexane | 1,3-dioxolane | 5000 | ppm | 503 | ppm | residues of | no deposit formation | >240 | h |
| ative | | | | | | | cyclohexane | | | |
| Example 1 | | | | | | | | | | |
| Compar- | 1,4-dioxane | 1,3-dioxolane | 5000 | ppm | 503 | ppm | residues of 1,4- | no deposit formation | >240 | h |
| ative | | | | | | | dioxane | | | |
| Example 2 | | | | | | | | | | |
| Compar- | 1,4-dioxane | methanol | 5000 | ppm | 5500 | ppm | residues of 1,4- | pronounced deposit | 10 | h |
| ative | | | | | | | dioxane | formation | | |
| Example 3 | | | | | | | | | | |
| Compar- | 1,4-dioxane | water | 5000 | ppm | 5500 | ppm | residues of 1,4- | very pronounced | 2 | h |
| ative | | | | | | | dioxane | deposit formation | | |
| Example 4 | | | | | | | | | | |

Comparative Examples 1 to 4 show considerable residues of 1,4-dioxane or cyclohexane in the monomer condensate. Before recycling of the monomers, this has to be separated off by a complicated procedure.
Comparative Examples 3 and 4, in which >5000 ppm of proton donators are present, furthermore show deposit formation in the vapor lines and a substantially reduced service life.
On limitation, according to the invention, of low boilers and proton donors, a long service life in combination with a highly pure condensate results.

1. A process for the preparation of polyoxymethylenes, which comprises:
cationic polymerization of monomers of the polyoxymethylenes a) in the presence of initiators b) and, if appropriate, in the presence of regulators c) and subsequent deactivation and isolation of the polymer, wherein the total amount of proton donors is less than 5000 ppm in the entire polymerization.

2. The process according to claim 1, wherein the proton donors have a molecular weight of <250 g/mol.

3. The process according to claim 1, wherein proton donors having at least one OH group are used.

4. The process according to claim 1, wherein the total amount of proton donors is from 0.1 to 2000 ppm.

5. The process according claim 1, wherein the proton donors are selected from the group consisting of aliphatic or aromatic alcohols, water or water-comprising solutions of reactants, acids and mixtures thereof.

6. The process according to claim 1, wherein the residual monomers are removed and are recycled to the polymerization reactor or to the monomer unit.

7. The process according to claim 1, wherein the amount of low boilers in the entire polymerization—with the exception of the monomers used—is from 0.1 to 15 000 ppm.

8. The process according to claim 1, wherein the low boilers are aprotic.

9. The process according to claim 1, wherein the low boilers have a molar mass of <400 g/mol.

10. The process according to claim 1, wherein the low boilers have a boiling point of <160° C.

11. The process according to claim 2, wherein proton donors having at least one OH group are used.

12. The process according to claim 2, wherein the total amount of proton donors is from 0.1 to 2000 ppm.

13. The process according to claim 3, wherein the total amount of proton donors is from 0.1 to 2000 ppm.

14. The process according claim 2, wherein the proton donors are selected from the group consisting of aliphatic or aromatic alcohols, water or water-comprising solutions of reactants, acids and mixtures thereof.

15. The process according claim 3, wherein the proton donors are selected from the group consisting of aliphatic or aromatic alcohols, water or water-comprising solutions of reactants, acids and mixtures thereof.

16. The process according claim 4, wherein the proton donors are selected from the group consisting of aliphatic or aromatic alcohols, water or water-comprising solutions of reactants, acids and mixtures thereof.

17. The process according to claim 2, wherein the residual monomers are removed and are recycled to the polymerization reactor or to the monomer unit.

18. The process according to claim 3, wherein the residual monomers are removed and are recycled to the polymerization reactor or to the monomer unit.

19. The process according to claim 4, wherein the residual monomers are removed and are recycled to the polymerization reactor or to the monomer unit.

20. The process according to claim 5, wherein the residual monomers are removed and are recycled to the polymerization reactor or to the monomer unit.
